(19) United States
(12) Patent Application Publication
(10) Pub. No.: US 2013/0335635 A1
(43) Pub. Date: Dec. 19, 2013

(54) Video Analysis Based on Sparse Registration and Multiple Domain Tracking

(71) Applicants: Bernard Ghanem, Thuwal (SA); Shaunak Ahuja, Singapore (SG); Tianzhu Zhang, Singapore (SG); Indriyati Atmosukarto, Singapore (SG)

(72) Inventors: Bernard Ghanem, Thuwal (SA); Shaunak Ahuja, Singapore (SG); Tianzhu Zhang, Singapore (SG); Indriyati Atmosukarto, Singapore (SG)

(21) Appl. No.: 13/830,015

(22) Filed: Mar. 14, 2013

Related U.S. Application Data
(60) Provisional application No. 61/614,146, filed on Mar. 22, 2012.

(51) Int. Cl. H04N 5/14

(52) U.S. Cl. CPC H04N 5/14
USPC 348/659; 348/571

(57) ABSTRACT

A video of a scene includes multiple frames, each of which is registered using sparse registration to spatially align the frame to a reference image of the video. Based on the registered multiple frames as well as both an image domain and a field domain, one or more objects in the video are tracked using particle filtering. Object trajectories for the one or more objects in the video are also generated based on the tracking, and can optionally be used in various manners.

### RELATED APPLICATIONS

This application claims the benefit under 35 U.S.C. §119(e) of U.S. Provisional Application No. 61/614,146, filed Mar. 22, 2012, which is hereby incorporated by reference herein in its entirety.

### BACKGROUND

A large amount of content is available to users today, such as video content. Oftentimes there is information included in video content that, if extracted, would be valuable to users. For example, video content may be a recorded sporting event and various useful information regarding the players or other aspects of the sporting event would be useful to coaches or analysts if available. While such information can sometimes be extracted by a user watching the video content, such extraction is very time-consuming. It remains difficult to automatically extract such useful information from video content.

### SUMMARY

This Summary is provided to introduce subject matter that is further described below in the Detailed Description. Accordingly, the Summary should not be considered to describe essential features nor used to limit the scope of the claimed subject matter.

In accordance with one or more aspects, a video of a scene including multiple frames is obtained. Using sparse registration, the multiple frames are registered to spatially align each of the multiple frames to a reference image. Based on the registered multiple frames as well as both an image domain and a field domain, one or more objects in the video are tracked. Based on the tracking, object trajectories for the one or more objects in the video can be generated.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 illustrates an example system implementing the video analysis based on sparse registration and multiple domain tracking in accordance with one or more embodiments.

FIG. 2 illustrates an example system implementing the video analysis based on sparse registration and multiple domain tracking in accordance with one or more embodiments.

FIG. 3 is a flowchart illustrating an example process for implementing video analysis based on sparse registration and multiple domain tracking in accordance with one or more embodiments.

FIG. 4 is a block diagram illustrating an example computing device in which the video analysis based on sparse registration and multiple domain tracking can be implemented in accordance with one or more embodiments.

### DETAILED DESCRIPTION

Video analysis based on video registration and object tracking is discussed herein. A video of a scene includes multiple frames. Each of the multiple frames is registered, using sparse registration, to spatially align the frame to a reference image of the video. Based on the registered multiple frames as well as both an image domain and a field domain, one or more objects in the video are tracked using particle filtering. Object trajectories for the one or more objects in the video are also generated based on the tracking The one or more object trajectories can be used in various manners, such as to display a 3-dimensional (3D) scene with 3D models animated based on the object trajectories, or to display one or more statistics determined based on the object trajectories.

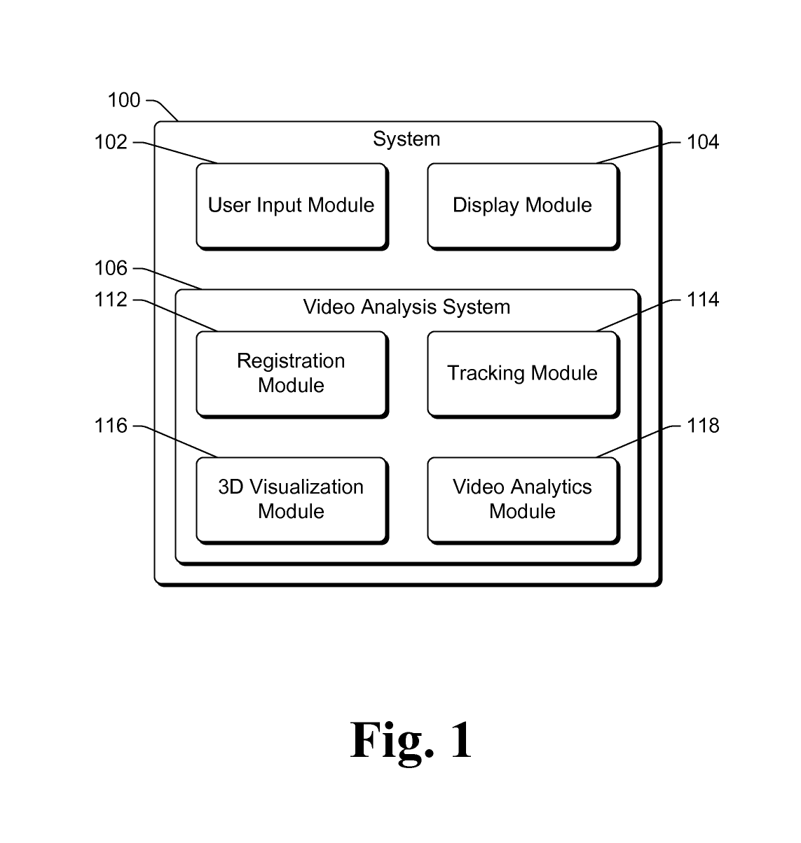

FIG. 1 illustrates an example system 100 implementing the video analysis based on sparse registration and multiple domain tracking in accordance with one or more embodiments. System 100 includes a user input module 102, a display module 104, and a video analysis system 106. Video analysis system 106 includes a registration module 112, a tracking module 114, a 3D visualization module 116, and a video analytics module 118. Although particular modules are illustrated in FIG. 1, it should be noted that functionality of one or more modules can be separated into multiple modules, and/or that functionality of one or more modules can be combined into a single module.

In one or more embodiments, system 100 is implemented by a single device. Any of a variety of different types of devices can be used to implement system 100, such as a desktop or laptop computer, a server computer, a tablet or notepad computer, a cellular or other wireless phone, a television or set−top box, a game console, and so forth. Alternatively, system 100 can be implemented by multiple devices, with different devices including different modules. For example, one or more modules of system 100 can be implemented by one device (e.g., a desktop computer), while one or more other modules of system 100 are implemented by another device (e.g., a server computer accessed over a communication network). In embodiments in which system 100 is implemented by multiple devices, the multiple devices can communicate with one another over various wired and/or wireless communication networks (e.g., the Internet, a local area network (LAN), a cellular or other wireless phone network, etc.) or other communication media (e.g., a universal serial bus (USB) connection, a wireless USB connection, and so forth).

User input module 102 receives inputs from a user of system 100, and provides an indication of those user inputs to various modules of system 100. User inputs can be provided by the user in various manners, such as by touching portions of a touchscreen or touchpad with a finger or stylus, manipulating a mouse or other cursor control device, pressing keys or buttons, providing audible inputs that are received by a microphone of system 100, moving hands or other body parts that are detected by an image capture device of system 100, and so forth.

Display module 104 displays a user interface (UI) for system 100, including displaying images or other content. Display module 104 can display the UI on a screen of system 100, or alternatively provide signals causing the UI to be displayed on a screen of another system or device.

Video analysis system 106 analyzes video, performing a semantic analysis of activities and interactions in video. The system 106 can also track objects such as people, animals, vehicles, other moving items, and so forth. The video can include various scenes, such as sporting events (e.g., an American football game, a soccer game, a hockey game, a race, etc.), public areas (e.g., stores, shopping centers, airports, train stations, public parks, etc.), private or restricted-access areas (e.g., employee areas of stores, office buildings, hospitals, etc.), and so forth.

Registration module 112 analyzes the video and spatially aligns frames of the video in the same coordinate system determined by a reference image. This registration is performed at least in part to account for non-translating motion (e.g., panning, tilting, and/or zooming) that the camera may be undergoing. Registration module 112 analyzes the video using sparse representation and compressive sampling, as discussed in more detail below.

Tracking module 114, which tracks objects in video in a particle filter framework, uses the output of registration module 112 to locate and display object trajectories in a reference system. In the particle filter framework, particles (potential objects) are proposed in the current frame based upon the temporally evolving probability of the object location and appearance in the next frame given previous motion and appearance. Amongst these sample particles, the particle with the highest similarity to the previous object track is chosen as the current track. This similarity is defined according to appearance, motion, and position in the reference system, as discussed in more detail below. Accordingly, each object is detected and tracked in the original video, and its location is displayed in the reference system from the time the object appears in the video until the object leaves the field of view. As such, each object is associated with a spatiotemporal trajectory that delineates its position over time in the reference system, as discussed in more detail below.

The objects tracked by tracking module 114, and their associated trajectories, can be used in various manners by system 106 to analyze the video. In one or more embodiments, 3D visualization module 116 visualizes the tracked objects in a 3D setting by embedding generic 3D object models in a 3D world, with the positions of the 3D objects at any given time being determined by their tracks (as identified by tracking module 114). In one or more embodiments, 3D visualization module 116 assumes that the pose of a 3D object is perpendicular to the static planar background, allowing module 116 to simulate different camera views that could be temporally static or dynamic. For example, the user can choose to visualize the same video from a single camera viewpoint (that can be different from the one used to capture the original video) or from a viewpoint that also moves over time (e.g., when the viewpoint is set at the location of one of the objects being tracked).

In one or more embodiments, video analytics module 118 facilitates identification of various actions, events, and/or activities present in a video. Video analytics module 118 can facilitate identification of such events and/or activities in various manners. For example, the spatiotemporal trajectories identified by tracking module 114 can be used to distinguish among various classes of events and activities (e.g. walking, running, various group formations and group motions, abnormal activities, and so forth). Video analytics module 118 can also take into account knowledge about the scene in the video to generate various statistics and/or patterns regarding the video. For example, video analytics module 118 can, taking into account knowledge from the sports domain (e.g., which module 118 is configured with or otherwise has access to), extract various statistics and patterns from individual games (e.g., distance covered by a specific player in a time interval, the average speed of a player, a type of initial formation of a group of players, etc.) or from a set of games (e.g., the retrieval of player motions that are the most similar to a query player motion).

Video analysis system 106 can be used in various situations, such as when a non-translating camera (e.g., a pan-tilt−zoom or PTZ camera) is capturing video of a dynamic scene where tracking objects and analyzing their motion patterns is desirable. One such situation is sports video analytics, where there is a growing need for automatic processing techniques that are able to extract meaningful information from sports footage. System 106 can serve as an analysis/training tool for coaches and players alike. For example, system 106 can help coaches quickly analyze large numbers of video clips and allow them to reliably extract and interpret statistics of different sports events. This capability can help coaches and players understand their opponents better and plan their own strategies accordingly. Video analysis system 106 can also be used in various other situations, such as video surveillance in public areas (e.g., airports or supermarkets). For example, system 106 can be used to monitor customer motion patterns over time to evaluate and possibly improve product placement inside a supermarket.

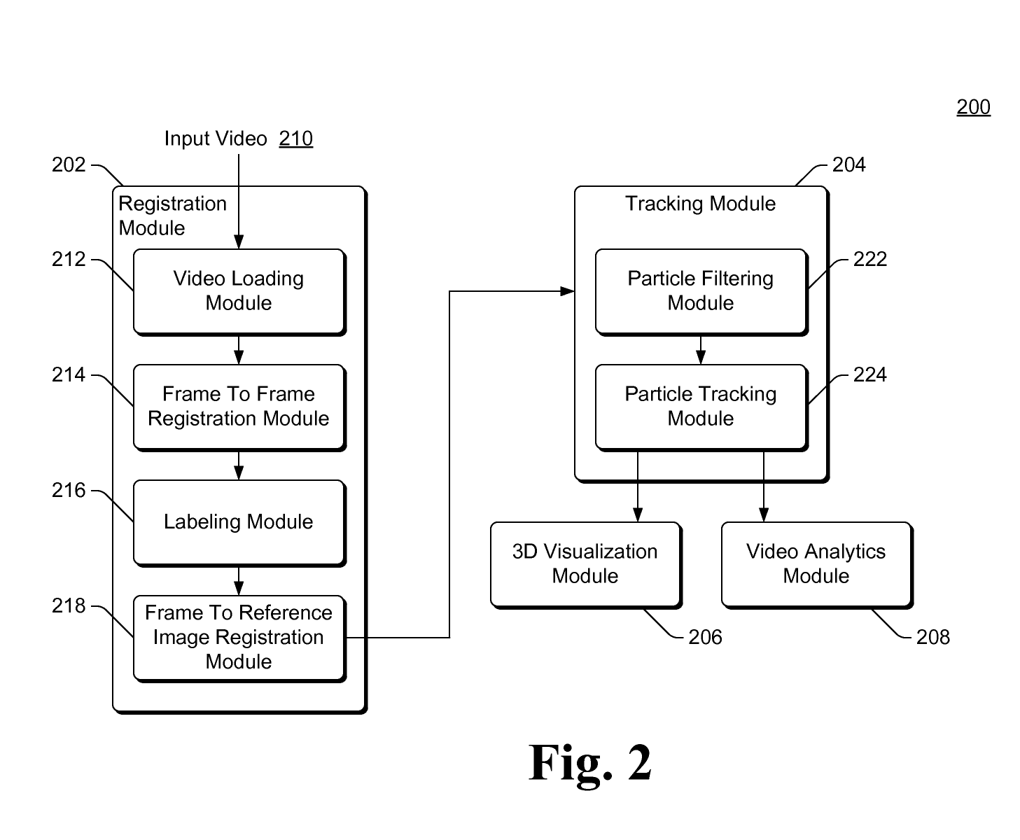

FIG. 2 illustrates an example system 200 implementing the video analysis based on sparse registration and multiple domain tracking in accordance with one or more embodiments. System 200 can be, for example, a system 106 of FIG. 1. System 200 includes a registration module 202 (which can be, for example, a registration module 112 of FIG. 1), a tracking module 204 (which can be, for example, a tracking module 114 of FIG. 1), a 3D visualization module 206 (which can be, for example, a 3D visualization module 116 of FIG. 1), and a video analytics module 208 (which can be, for example, a video analytics module 118 of FIG. 1). Alternatively, 3D visualization module 206 and/or video analytics module 208 can be optional, and need not be included in system 200.

Registration module 202 includes a video loading module 212, a frame to frame registration module 214, a labeling module 216, and a frame to reference image registration module 218. Tracking module 204 includes a particle filtering module 222 and a particle tracking module 224. Although particular modules are illustrated in FIG. 2, it should be noted that functionality of one or more modules can be separated into multiple modules, and/or that functionality of one or more modules can be combined into a single module.

Video loading module 212 obtains input video 210. Input video 210 can be obtained in various manners, such as passed to video loading module 212 as a parameter, retrieved from a file (e.g., identified by a user of system 200 or other component or module of system 200), and so forth. Input video 210 can be obtained after the fact (e.g., a few days or weeks after the video of the scene is captured or recorded) or in real time (e.g., the video being streamed or otherwise made available to video loading module 212 as the scene is being captured or recorded (or within a few seconds or minutes of the scene being captured or recorded)). Input video 210 can include various types of scenes (e.g., a sporting event, surveillance video from a public or private area, etc.) as discussed above. Video loading module 212 provides input video 210 to frame to frame registration module 214, which performs frame to frame registration for the video. Video loading module 212 can provide input video 210 to frame to frame registration module 214 in various manners, such as by passing the video as a parameter, storing the video in a location accessible to module 214, and so forth.

Video registration refers to spatially aligning video frames in the same coordinate system (also referred to as a reference system) determined by a reference image. By registering the video frames, registration module 202 accounts for a moving (non-stationary) camera and/or non-translating camera motion (e.g., a panning, tilting, and/or zooming). System 200 is thus not reliant upon using one or more stationary cameras. Video is made up of multiple images or frames, and the spatial transformation between the t^{th} video frame Iₜ and the reference image Iᵣ governs the relative camera motion between these two images. The reference image Iᵣ is typically one of the frames or images of the video. The reference image Iᵣ can be the first frame or image of the video, or alternatively any other frame or image of the video. In one or more embodiments, the spatial transformation between consecutive frames used by the video analysis based on sparse registration and multiple domain tracking techniques discussed herein is the projective transform, also referred to as the homography.

In contrast to techniques that detect specific structures (e.g., points and lines), find potential correspondences, and use a random sampling method to choose inlier correspondences, frame to frame registration module 214 uses a parameter-free, robust registration method that avoids explicit structure matching by matching entire images or image patches (portions of images). This parameter-free technique matching entire images or image patches is also referred to as sparse registration. Registration module 214 frames the registration problem in a sparse representation setting, computing a homography that maps one image to the other by assuming that outlier pixels (e.g., pixels belonging to moving objects) are sufficiently sparse (e.g., less than a threshold number are present) in each image. No other prior information need be assumed by registration module 214. Module 214 performs robust video registration by solving a sequence of l_{I} minimization problems, each of which can be solved in various manners (such as using the Inexact Augmented Lagrangian Method (IALM)). If point correspondences are available and reliable, module 214 can incorporate the point correspondences into the robust video registration as additional linear constraints. The robust video registration is parameter-free, except for tolerance values (stopping criteria) that determine when convergence occurs. Module 214 exploits a hybrid coarse-to-fine and random (or pseudo-random) sampling strategy along with the temporal smoothness of camera motion to efficiently (e.g., with sublinear complexity in the number of pixels) perform robust video registration, as discussed in more detail below.

Frame to frame registration module 214 estimates a sequence of homographies that each map a video frame into the next consecutive video frame of a video having a number of video frames or images, where F refers to the number of video frames or images. A value Iₜ represents the image at time t, with IₜεR^{M×N}, where R refers to the set of real numbers, M represents a number of pixels in the image in one dimension (e.g., horizontal), and N represents a number of pixels in the image in the other dimension (e.g., vertical). Additionally, \vec{i}ₜ represents a vectorized version of the image at time t. The homography from one image to the next (the homography from \vec{i}ₜ to \vec{i}ₜ₊₁) is referred to as \vec{h}ₜ. Additionally, the result of spatially transforming image \vec{i}ₜ using \vec{h}ₜ is referred to as \vec{i}ₜ₊₁=\vec{i}ₜ∘\vec{h}ₜ. The error arising from outlier pixels (e.g., pixels belonging to moving objects) is referred to as \vec{e}ₜ=ĩₜ₊₁−\vec{i}iₜ₊₁, and this error vector \vec{e}ₜ is assumed to be sufficiently sparse. Registration module 202 also assumes that the homographies are general (e.g., 8 DOF (degrees of freedom)). It should be noted that the homographies can be changed to accommodate other models based on the nature of each homography (e.g., rotation and slight zoom).

Registration module 214 can also apply these representations to image patches, with multiple patches in one image jointly undergoing the same homography, resulting in more linear equality constraints. A homography for an image patch in one image to the corresponding image patch in the next image can be estimated by registration module 214 analogous to estimation of a homography from one image to the next, and the estimated homography used for all images patches in the frames. Alternatively, a homography for each image patch in one image to the corresponding image patch in the next image can be estimated by registration module 214 analogous to estimation of a homography from one image to the next, and the estimated homographies for the image patches combined (e.g., averaged) to determine a homography from that one image to the next. Image patches can be determined in different manners, such as by dividing each image into a regular grid (e.g., in which case each image patch can be a square in the grid), selecting other geometric shapes as image patches (e.g., other rectangles or triangles), and so forth.

Frame to frame registration module 214 treats the robust video registration problem as being equivalent to estimating the optimal (or close to optimal) sequence of homographies that both map consecutive frames and render the sparsest (or close to the sparsest) error. Registration module 214 need not, and typically does not, model the temporal relationship between homographies. Thus, module 214 can decouple the robust video registration problem as F−1 optimization problems.

Frame to frame registration module 214 uses a robust video registration framework, which is formulated as follows. For the frame at each time t, with 1≦t≦F−1, rather than seeking the sparsest solution (with minimum l₀ norm), the cost function is replaced with its convex envelope (with l₁ norm) and a sparse solution is sought according to the following equation:

$${min}_{{\vec{e}}_{t + 1}} {‖ {\vec{e}}_{t + 1} ‖}_{1} \\ subject to \text{:} {\vec{i}}_{t} ∘ {\vec{h}}_{t} = {\vec{i}}_{t + 1} + {\vec{e}}_{t + 1} \qquad ( 1 )$$

In equation (1), the objective function is convex but the equality constraint is not convex. Accordingly, the constraint is linearized around a current estimate of the homography and the linearized convex problem is solved iteratively. Thus, at the (k+1)^{th} iteration, registration module 214 starts with an estimate of each homography denoted as \vec{h}ₜ^{(k)}, and the current estimate will be \vec{h}ₜ^{(k+1)}=\vec{h}ₜ^{(k)+Δ\vec{h}}ₜ. Accordingly, equation (1) can be relaxed to the following equation:

$${min}_{Δ {\vec{h}}_{t} , {\vec{e}}_{t + 1}} {‖ {\vec{e}}_{t + 1} ‖}_{1} \\ subject to \text{:} {J}_{t}^{( k )} Δ {\vec{h}}_{t} - {\vec{e}}_{t + 1} = {\vec{δ}}_{t + 1}^{( k )} \qquad ( 2 )$$

where \vec{δ}ₜ₊₁^{(k)}=\vec{i}ₜ₊₁−\vec{i}ₜ∘\vec{h}ₜ^{(k)} represents the error incurred at iteration k, Jₜ^{(k)} represents the Jacobian of \vec{i}ₜ∘\vec{h}ₜ with respect to \vec{h}ₜ, and Jₜ^{(k)}εR^{MN×8}. Applying the chain rule, Jₜ^{(k)} can be written in terms of the spatial derivatives of \vec{i}ₜ.

Frame to frame registration module 214 computes the k^{th} iteration of equation (2) and the sequence of homographies as follows. The optimization problem in equation (2) is convex but non-smooth due to the l₁ objective. In one or more embodiments, registration module 214 solves equation (2) using the well-known Inexact Augmented Lagrangian Method (IALM), which is an iterative method having update rules that are simple and closed form, and having a linear convergence rate. Additional information regarding the Inexact Augmented Lagrangian Method can be found, for example, in Andrew Wagner, John Wright, Arvind Ganesh, Zihan Zhou, Hossein Mobahi, and Yi Ma, “Towards a Practical Face Recognition System: Robust Alignment and Illumination by Sparse Representation”, IEEE TPAMI, May 2011, and Zhengdong Zhang, Xiao Liang, Arvind Ganesh, and Yi Ma, “TILT: transform invariant low-rank textures”, ACCV, pp. 314-328, 2011. Although registration module 214 is discussed herein as using IALM, it should be noted that other well-known techniques can be used for solving equation (2). For example, registration module 214 can use the alternating direction method (ADM), the subgradient descent method, the accelerated proximal gradient method, and so forth.

Using IALM, constraints are added as penalty terms in the objective function with first order and second order Lagrangian multipliers. The augmented Lagrangian function L for equation (2) is the equation:

$$L = {‖ {{e}^{->}}_{t + 1} ‖}_{1} + {{λ}^{->}}^{T} ( {J}_{t}^{( k )} Δ {{h}^{->}}_{t} - {{δ}^{->}}_{t + 1}^{( k )} - {{e}^{->}}_{t + 1} ) + \frac{μ}{2} {‖ {J}_{t}^{( k )} Δ {{h}^{->}}_{t} - {{δ}^{->}}_{t + 1}^{( k )} - {{e}^{->}}_{t + 1} ‖}_{2}^{2} \qquad ( 3 )$$

where \vec{λ} and μ are the dual variables to the augmented dual problem in equation (3) and which are computed iteratively (e.g., using the example algorithm in Table I discussed below).

The unconstrained objective of equation (3) is minimized (or reduced) using alternative optimization or reduction steps, which lead to simple closed form update rules. Updating Δ\vec{h}ₜ includes solving a least squares problem. Conversely, updating \vec{e}ₜ₊₁ involves using the well-known l₁ soft−thresholding identity as follows:

$${S}_{λ} {( a )}^{->} = argmin ( λ {‖ {x}^{->} ‖}_{1} + \frac{1}{2} {‖ {x}^{->} - {a}^{->} ‖}_{2}^{2} )$$

where S_{λ}(\vec{a}) refers to the soft−thresholding identity, and S_{λ}(aᵢ)=max(0,|aᵢ|−λ).

Table I illustrates an example algorithm used by frame to frame registration module 214 in performing robust video registration in accordance with one or more embodiments. Line numbers are illustrated in the left−hand column of Table I. Registration module 214 employs a stopping criteria to identify when convergence has been obtained. In one or more embodiments, the stopping criteria compares successive changes in the solution to a threshold value (e.g., 0.1), and determines that convergence has been obtained if the successive changes in the solution are less than (or alternatively less than or equal to) the threshold value.

TABLE I

| | Input: \vec{i}ₜ∀t, \vec{h}ₜ⁽⁰⁾∀t, k = 0, ρ > 1 |
|---|---|
| 1 | while not converged do |
| 2 | compute \vec{δ}ₜ^{(k)} and Jₜ^{(k)}∀t |
| 3 | m = 0, Δ\vec{h}ₜ^{(m)} = \vec{0}, \vec{λ}^{(m)} = 0, μ^{(m)} > 0 |
| 4 | while not converged do |
| 5 | ${\vec{e}}_{t + 1}^{( m + 1 )} = {S}_{\frac{1}{{μ}^{( m )}}} ( {J}_{t}^{( k )} Δ {\vec{h}}_{t}^{( m )} - {\vec{δ}}_{t + 1}^{( k )} + \frac{{μ}^{( j )} {\vec{λ}}^{( m )}}{2} )$ |
| 6 | ${\vec{h}}_{t}^{( m + 1 )} = {( {J}_{t}^{( k ) T} {J}_{t}^{( k )} )}^{- 1} {J}_{t}^{( k ) T} ( {\vec{δ}}_{t + 1}^{( k )} + {\vec{e}}_{t + 1}^{( m + 1 )} - \frac{{\vec{λ}}^{( m )}}{{μ}^{( m )}} )$ |
| 7 | \vec{λ}^{(m+1)} = \vec{λ}^{(m)} \| + μ^{(m)}(Jₜ^{(k)T}Δ\vec{h}ₜ^{(m+1)} − \vec{δ}ₜ₊₁^{(k)} − \vec{e}ₜ₊₁^{(m+1)}) |
| 8 | μ^{(m+1)} = ρμ^{(m)}; m ← m + 1 |
| 9 | end |
| 10 | \vec{h}ₜ^{(k+1)} = \vec{h}ₜ^{(k)} + Δ\vec{h}ₜ^{(m)}; \vec{e}ₜ₊₁^{(k+1)} = \vec{e}ₜ₊₁^{(m)} |
| 11 | end |

In Table I, m refers to the iteration count or number, and p refers to the expansion factor of μ as ρ makes μ larger every iteration. In one or more embodiments, ρ has a value of 1.1, although other values for ρ can alternatively be used. The input to the algorithm is all the frames (images) of the video and initial homographies between the frames of the video. The initial homographies are set to the same default value, such as the identity matrix (e.g., diag(1,1,1)). Lines 4-9 implement the IALM, solving equation (3) above, and are repeated until convergence (e.g., successive changes in the solution (L) of equation (3) are less than (or less than or equal to) a threshold value (e.g., 0.1)). Lines 1-3 and 10-11 implement an outer loop that is repeated until convergence (successive changes in the solution (the homography) are less than (or less than or equal to) a threshold value (e.g., 0.0001).

In one or more embodiments, frame to frame registration module 214 employs spatial and/or temporal strategies to improve the efficiency of the robust video registration. Temporally, camera motion typically varies smoothly, so module 214 can initialize \vec{h}ₜ₊₁ with \vec{h}ₜ.

Spatially, module 214 uses a coarse-to-fine strategy in which the solution at a coarser level is the initialization for a finer level. Using this coarse-to-fine strategy, frame to frame registration module 214 reduces the number of pixels processed per level by sampling pixels to consider in the updating equations (e.g., lines 5 and 6 of the algorithm in Table I). The sampling of pixels can be done in different manners, such as randomly, pseudo-randomly, according to other rules or criteria, and so forth. For example, if αₜ refers to the ratio of nonzero elements in \vec{e} and d_{MIN} refers to the minimum subspace dimensionality, then d_{MIN} is the smallest nonnegative scalar that satisfies the following:

$${d}_{MIN} + \frac{{d}_{MIN}}{2 {α}_{t} MN} \geq log MN$$

By setting

$${α}_{t} = \frac{{‖ {{e}^{->}}_{t + 1} ‖}_{1}}{MN} ,$$

the random (or pseudo-random) sampling rate can be adaptively selected. The value of αₜ can vary and can result in sampling rates of, for example, 15 to 20% of the pixels in the frame.

In one or more embodiments, equation (2) is also extended to the case where auxiliary prior knowledge on outlier pixels is known. This auxiliary prior knowledge is represented as a matrix W that pre-multiplies \vec{e}ₜ₊₁ to generate a weighted version of equation (2). The matrix W can be, for example, W=diag(\vec{w}) where wᵢ is the probability that pixel i is an inlier. For example, if an object (e.g., human) detector is used, then wᵢ is inversely proportional to the detection score. And, if W is invertible, then the IALM discussed above can be used, but replacing \vec{e}ₜ₊₁ with W\vec{e}ₜ₊₁.

Furthermore, in one or more embodiments frame to frame registration module 214 assumes that the image Iₜ₊₁ is scaled by a positive factor β to represent a global change in illumination. Registration module 214 further assumes that β=φ². A corresponding update rule can also be added to the robust video registration algorithm in Table I as follows. In place of equation (2) discussed above, the following equation is used:

$${min}_{Δ {{h}^{->}}_{t} , {{e}^{->}}_{t + 1} , ϕ} {‖ {{e}^{->}}_{t + 1} ‖}_{1} \\ subject to \text{:} {ϕ}^{2} {{i}^{->}}_{t + 1} - {J}_{t}^{( k )} Δ {{h}^{->}}_{t } + {{e}^{->}}_{t + 1} = {{i}^{->}}_{t} ∘ {{h}^{->}}_{t}^{( k )} \qquad ( 4 )$$

At the (m+1)^{th} iteration of IALM, the Lagrangian function with respect to φ is defined as the equation:

$$L ( ϕ ) = {‖ {{e}^{->}}_{t + 1}^{( m + 1 )} ‖}_{1} + {( {ϕ}^{2} {{i}^{->}}_{t + 1} - {\tilde{i}}_{t + 1}^{( m + 1 )} )}^{T} {{λ}^{->}}^{( m )} + \frac{μ}{2} {‖ {ϕ}^{2} {{i}^{->}}_{t + 1} - {\tilde{i}}_{t + 1}^{( m + 1 )} ‖}_{2}^{2}$$

where:

ĩₜ₊₁^{(m+1)}=Jₜ^{(k)}Δ\vec{h}ₜ^{(m+1)}−\vec{e}ₜ₊₁^{(m+1)}+\vec{i}ₜ∘\vec{h}ₜ^{(k)}.

By setting

$$\frac{\partial L}{\partial ϕ} = 0 ,$$

the following update rule can be added to the robust video registration algorithm in Table I (e.g., and can be included as part of the while loop in lines 4-9):

$${ϕ}^{( m + 1 )} = \{ \begin{matrix}\sqrt{B} & if β \geq 0 \\ 0 & if β < 0\end{matrix}$$

where:

$$β = \frac{1}{{‖ {{i}^{->}}_{t + 1} ‖}_{2}^{2}} ( {{i}^{->}}_{t + 1}^{T} {\tilde{i}}_{t + 1}^{( m + 1 )} - \frac{1}{{μ}^{( m )}} {{i}^{->}}_{t + 1}^{T} {{λ}^{->}}^{( m )} ) .$$

Frame to frame registration module 214 generates, in solving equation (2), a sequence of homographies that map consecutive video frames of input video 210. This sequence of homographies is also referred to as the frame-to-frame homographies. Situations can arise, and oftentimes do arise when the scene included in the video is a sporting event, in which the input video 210 is a series of multiple video sequences of the same scene captured from different viewpoints (e.g., different cameras or camera positions). To account for these different viewpoints, registration module 202 makes the reference image Iᵣ common to the multiple video sequences.

Labeling module 216 identifies pixel pairs between a frame of each video sequence and the reference image, and can identify these pixel pairs in various manners such as automatically based on various rules or criteria, manually based on user input, and so forth. In one or more embodiments, labeling module 216 prompts a user of system 200 to label (identify) at least a threshold number (e.g., four) of pixel pairs between a frame of each video sequence and the reference image, each pixel pair identifying corresponding pixels (pixels displaying the same part of the scene) in the frame and the reference image. Labeling module 216 receives user inputs identifying these pixel pairs, and provides these pixel correspondences to frame to reference image registration module 218. Labeling module 216 can provide these pixel correspondences to frame to reference image registration module 218 in various manners, such as passing the pixel correspondences as a parameter, storing the pixel correspondences in a location accessible to module 218, and so forth.

Frame to reference image registration module 218 uses these pixel correspondences to generate a frame-to-reference homography for each video sequence. The frame-to-reference homography for a video sequence aligns the selected video frame (the frame of the video sequence for which the pixel pairs were selected) to the reference image using the Direct Linear Transformation (DLT) method. Additional information regarding the Direct Linear Transformation method can be found in Richard Hartley and Andrew Zisserman, “Multiple View Geometry in Computer Vision”, Cambridge University Press, 2^{nd} edition, 2004. Frame to reference image registration module 218 then uses the multiplicative property of homographies to combine, for each video sequence, the sequence of frame-to-frame homographies and the frame-to-reference homography to register the frames of the video sequence onto the reference image Iᵣ. The reference image Iᵣ is thus common to or shared among all video sequences captured of the same scene. The resultant sequence of homographies, registered onto the reference image Iᵣ, can then be used by tracking module 204 to track objects in input video 210.

It should be noted that the discussion of registration module 202 above accounts for non-stationary cameras. Alternatively, the techniques discussed herein can be used with stationary cameras. In such situations the frame to frame registration performed by module 214 need not be performed. Rather, video loading module 212 can provide input video 210 to labeling module 216, bypassing frame to frame registration module 214.

Tracking module 204 obtains the homographies (the sequence of homographies registered onto the reference image Iᵣ) generated by registration module 202. The homographies can be obtained in various manners, such as passed to tracking module 204 from registration module 202 as a parameter, retrieved from a file (e.g., identified by registration module 202 or other component or module of system 200), and so forth. Tracking module 204 tracks one or more objects in a dynamic scene, distinguishing the one or more objects from one another despite any visual perturbations (such as occlusion, camera motion, illumination changes, object resolution, and so forth).

Tracking module 204 includes a particle filtering module 222 and particle tracking module 224 that uses a particle filter based tracking algorithm that is based on multiple domains: both an image domain and a field domain. The image domain refers to the individual images or frames that are included in the video, and the particle filter based tracking algorithm analyzes various aspects of the individual images or frames that are included in the video. The field domain refers to the full field or area of the scene included in the video (any area included in at least a threshold number (e.g., one) images of the video). The field or area is oftentimes not fully displayed in a single image or frame of the video, but is typically displayed across multiple images or frames of the video (each of which can exclude portions of the scene) and thus is obtained from multiple images or frames of the video. The particle filter based tracking algorithm analyzes various aspects of the full field or area, across multiple images or frames of the video. The field domain is based on multiple images or frames of the video, and is thus also based on the homographies generated by registration module 202.

Particle filtering module 222 uses both object appearance information (e.g., color and shape) in the image domain and cross-domain contextual information in the field domain to track objects. This cross-domain contextual information refers to intra-trajectory contextual information and inter-trajectory contextual information, as discussed in more detail below. In the field domain, the effect of fast camera motion is reduced because the underlying homography transform from each frame to the field domain can be accurately estimated. Module 222 uses contextual trajectory information (intra-trajectory and inter-trajectory context) to improve the prediction of object states within a particle filter framework. Intra-trajectory contextual information is based on history tracking results in the field domain, and inter-trajectory contextual information is extracted from a compiled trajectory dataset based on trajectories computed from videos depicting similar scenes (e.g., the same sport, different stores of the same type (e.g., different supermarkets), different public areas of the same type (e.g., different airports or different train stations), and so forth).

By using cross-domain contextual information, particle filtering module 222 is able to alleviate various issues associated with object tracking Fast camera motion effects (e.g., parallax) can be reduced or eliminated in the field domain through the correspondence (based on the sequence of homographies generated by registration module 202) between points in the field and image domains. Camera motion is estimated by estimating the frame-to-frame homographies as discussed above. By registering the frames of the video sequence onto the reference image Iᵣ as discussed above to obtain the sequence of homographies registered onto the reference image Iᵣ, the effects of the camera motion in the video is “subtracted” or removed from the sequence of homographies registered onto the reference image Iᵣ. Additionally, the trajectory of each object typically has multiple characteristics that allow the object to be more predictable in the field domain than in the image domain, facilitating prediction of an object's next position. Furthermore, in some situations due to rules associated with the field (e.g., the rules of a particular sporting event), objects in different videos have similar trajectories. Accordingly, particle filtering module 222 can use prior object trajectories (e.g., from a trajectory dataset) to facilitate object tracking.

Particle filtering module 222 uses a particle filter framework to guide the tracking process. The cross-domain contextual information is integrated into the framework and operates as a guide for particle propagation and proposal. The particle filter itself is a Bayesian sequential importance sampling technique for estimating the posterior distribution of state variables characterizing a dynamic system. The particle filter provides a framework for estimating and propagating the posterior probability density function of state variables regardless of the underlying distribution, and employs two base operations: prediction and update. Additional discussions of the particle filter framework and the particle filter can be found in Michael Isard and Andrew Blake, “Condensation—conditional density propagation for visual tracking”, International Journal of Computer Vision, vol. 29, pp. 5-28, 1998, and Arnaud Doucet, Nando De Freitas, and Neil Gordon, “Sequential monte carlo methods in practice”, in Springer-Verlag, New York, 2001.

Particle filtering module 222 uses the particle filter and particle filter framework for tracking as follows. The state variable describing the parameters of an object at time t is referred to as xₜ. Various different parameters of the object can be described by the state variable, such as appearance features of the object (e.g., color of the object, shape of the object, etc.), motion features of the object (e.g., a direction of the object, etc.), and so forth. The state variable can thus also be referred to as a state vector. The predicting distribution of xₜ given all available observations z_{1:t-1}={z₁, z₂, . . . , z₁} up to time t−1 is referred to as p(xₜ|z_{1:t-1}), and is recursively computed using the following equation:

p(xₜ|z_{1:t-1})=∫p(xₜ|xₜ₋₁)p(xₜ₋₁|z_{1:t-1})dxₜ₋₁ (5)

At time t, the observation zₜ is available and the state vector is updated using Bayes rule, per the following equation:

$$p ( {x}_{t} \vert {z}_{1 \text{:} t} ) = \frac{p ( {z}_{t} \vert {x}_{t} ) p ( {x}_{t} \vert {z}_{1 \text{:} t - 1} )}{p ( {z}_{t} \vert {z}_{1 \text{:} t - 1} )} \qquad ( 6 )$$

where p(zₜ|xₜ) refers to the observation likelihood.

In the particle filter framework, the posterior p(xₜ|z_{1:t}) is approximated by a finite set of N samples, which are also called particles, and are referred to as {xₜⁱ}ᵢ₌₁^{N} with importance weights wᵢ. The candidate samples xₜⁱ are drawn from an importance distribution q(xₜ|x_{1:t-1}, z_{1:t}) and the weights of the samples are updated per the following equation:

$${w}_{t}^{i} = {w}_{t - 1}^{i} \frac{p ( {z}_{t} \vert {x}_{t}^{i} ) p ( {x}_{t}^{i} \vert {x}_{t - 1}^{i} )}{q ( {x}_{t} \vert {x}_{1 \text{:} t - 1} , {z}_{1 \text{:} t} )} \qquad ( 7 )$$

Using equation (7), to avoid degeneracy the particles are resampled to generate a set of equally weighted particles by their importance weights.

Using the particle filter framework, particle filtering module 222 models the observation likelihood and the proposal distribution as follows. For the observation likelihood p(zₜ|xₜ), a multi-color observation model based on Hue-Saturation-Value (HSV) color histograms is used, and a gradient−based shape model using Histograms of Oriented Gradients (HOG) is also used. Additional discussions of the multi-color observation model and gradient−based shape model can be found in Kenji Okuma, Ali Taleghani, Nando De Freitas, O De Freitas, James J. Little, and David G. Lowe, “A boosted particle filter: Multitarget detection and tracking,” in ECCV, 2004, pp. 28-39.

Particle filtering module 222 applies the Bhattacharyya similarity coefficient to define the distance between HSV and HOG histograms respectively. Additionally, module 222 divides the tracked regions into two sub-regions (2×1) in order to describe the spatial layout of color and shape features for a single object. Particle filtering module 222 also models the proposal distribution q(xₜ|x_{1:t-1}, z_{1:t}) using the following equation:

q(xₜ|x_{1:t-1},z_{1:t})=γ₁p(xₜ|xₜ₋₁)+γ₁p(xₜ|xₜ₋₁)+γ₂p(xₜ|x_{t-L:t-1})+γ₃p(xₜ|x_{1:t-1},T_{1:K}) (8)

The values of γ₁, γ₂, and γ₃ can be determined in different manners. In one or more embodiments, the values of γ₁, γ₂, and γ₃ are determined using a cross-validation set. For example, the values of γ₁, γ₂, and γ₃ can be equal, and each set to ⅓. In equation (8), module 222 fuses intra-trajectory contextual information and inter-trajectory contextual information. The generation of the intra-trajectory contextual information and inter-trajectory contextual information is discussed below.

In one or more embodiments, the intra-trajectory contextual information is determined as follows. For a tracked object from frame 1 to t−1, particle filtering module 222 obtains t−1 points {p₁, p₂, . . . , pₜ₋₁}, which correspond to a short trajectory denoted as T₀. These points are points in the reference system, obtained by transforming points in frames of the video to the reference image (and thus to the reference system) using the sequence of homographies registered onto the reference image Iᵣ as generated by registration module 202. Particle filtering module 222 predicts the next state at time t using the previous states in a non-trivial data-driven fashion. For each object being tracked, the previous states of the object can be used to assist in predicting the next state of the object in the field domain.

Particle filtering module 222 considers the most recent L points in the trajectory of an object to predict the state at time t. In one or more embodiments, L has a value of 30, although other values for L can alternatively be used. To obtain robust intra-trajectory information, module 222 adopts a point p_{t-L} as the start point, and uses the other more current points to define the difference as ∇pₗ=(p_{t-L+1}−p_{t-L})/l where ∇pₗ is also denoted as ∇pₗ=(∇xₗ,∇yₗ), l=1, 2, . . . , L. Accordingly, given ∇p_{1:L-1}, the probability of ∇p_{L} is defined using the following equation:

$$p ( ∇ {p}_{L} \vert ∇ {p}_{1 \text{:} L - 1} ) = \frac{{e}^{- \frac{1}{2} {( ∇ {p}_{L} - {u}_{∇ {p}_{l}} )}^{T} {Σ}^{- 1} ( ∇ {p}_{L} - {u}_{∇ {p}_{l}} )}}{2 π {\vert Σ \vert}^{\frac{1}{2}}} \qquad ( 9 )$$

where Σ is assumed to be a diagonal matrix.

Furthermore, to consider the temporal information, each ∇pₗ is weighted with λₗ defined as

$${λ}_{1} = \frac{{e}^{- {l}^{2} / {θ}^{2}}}{{Σ}_{l} {e}^{- {l}^{2} / {θ}^{2}}} .$$

Based on the weight λₗ, u_{∇p}_{ₗ} and Σ are defined as follows:

u_{∇p}_{ₗ}=Σₗ₌₁^{L-1}λₗ∇pₗ

Σ=diag(θ_{∇x}_{ₗ}²,θ_{∇y}_{ₗ}²)

where θ_{∇x}_{ₗ}² and θ_{∇y}_{ₗ}² are defined as follows:

$${θ}_{∇ {x}_{l}}^{2} = \frac{{\sum }_{l = 1}^{L - 1} {λ}_{1}}{{( {\sum }_{l = 1}^{L - 1} {λ}_{l} )}^{2} - {\sum }_{l = 1}^{L - 1} {λ}_{l}^{2}} {\sum }_{l = 1}^{L - 1} {{λ}_{l} ( ∇ {x}_{l} - {u}_{∇ {x}_{l}} )}^{2}$$

$${θ}_{∇ {y}_{l}}^{2} = \frac{{\sum }_{l = 1}^{L - 1} {λ}_{1}}{{( {\sum }_{l = 1}^{L - 1} {λ}_{l} )}^{2} - {\sum }_{l = 1}^{L - 1} {λ}_{l}^{2}} {\sum }_{l = 1}^{L - 1} {{λ}_{l} ( ∇ {y}_{l} - {u}_{∇ {y}_{l}} )}^{2} .$$

Additionally, p(xₜ|x_{t-L:t-1}) in equation (8), reflecting the intra-trajectory contextual information, is defined as follows:

p(xₜ|x_{t-L:t-1})=p(∇p_{L}|∇p_{1:L-1}).

In one or more embodiments, the inter-trajectory contextual information is determined as follows. Determining the inter-trajectory contextual information is based on a dataset of different videos depicting similar scenes. For example, if the scene being analyzed is an American football game, then the dataset can be a set of 90-100 different football plays from different games, different teams, and so forth. Each video in the dataset can be pre-processed to register frames (e.g. to an overhead model of the football field) using the techniques discussed above (e.g., by registration module 202) or alternatively other registration techniques (such as those discussed in Robin Hess and Alan Fern, “Improved video registration using non-distinctive local image features”, in CVPR 2007).

Based on this dataset, particle filtering module 222 obtains the K nearest neighbor trajectories for each short trajectory T₀, and the K trajectories are referred to as T_{1:K}. The K nearest neighbors can be obtained in various manners, such as by use of dynamic time warping (e.g., as discussed in Hiroaki Sakoe, “Dynamic programming algorithm optimization for spoken word recognition”, IEEE Transactions on Acoustics, Speed, and Signal Processing, vol. 26, pp. 43-49, 1978). For each Tₖ, for k=1, . . . , K, module 204 calculates the Euclidean distance between its points and pₜ₋₁ (the last point in the trajectory T₀ (which is a point in the reference system, as discussed above)), and selects the point pₛ with the smallest distance. Module 222 then selects L points from the point pₛ to p_{s+L-1} in trajectory Tₖ to obtain pₖ(∇pᵢ|∇p_{1:L-1}), using equation (9) discussed above where ∇pᵢ=pᵢ−pₜ₋₁, and pᵢ is a point in the field domain.

Given T₀ and T_{1:K}, the probability of ∇pᵢ for each point pᵢ in the field domain is defined using the following equation:

p(∇pᵢ|T₀,T_{1:K})=Σₖ₌₁^{K}ηₖpₖ(∇pᵢ|∇p_{1:L-1}) (10)

where ηₖ is the weight of the k^{th} trajectory and is set as follows:

$${η}_{k} = exp ( - \frac{{( Dist ( {T}_{k} , {T}_{0} ) - {u}_{0} )}^{2}}{2 {δ}_{0}^{2}} )$$

where the Dist(Tₖ, T₀) is the distance between two trajectories Tₖ and T₀, which can be calculated in various manners such as using one or more well-known dynamic time warping (DTW) algorithms, and both the mean (u₀) and standard deviation (δ₀) are obtained from the dataset. The distances between any two trajectories can thus be obtained, and based on all of the distances between any two trajectories (or at least a threshold number of distances between at least a threshold number of pairs of trajectories), the mean (u₀) and standard deviation (δ₀) of all of the distances (or at least a threshold number of distances between at least a threshold number of pairs of trajectories) can be readily determined.

Based on T₀ and the K nearest neighbors, p(xₜ|x_{1:t-1},T_{1:K}) in equation (8), reflecting the inter-trajectory contextual information, is defined as follows:

p(xₜ|x_{1:t-1},T_{1:K})=p(∇pᵢ|T₀,T_{1:K}).

For a trajectory T₀ if there is no similar trajectory in the dataset, the K nearest neighbors have very small weights ηₖ as shown in equation (10). Accordingly, the probability p(∇pᵢ|T₀,T_{1:K}) is also very small, and little if any useful inter-trajectory contextual information is exploited.

Given the proposal distribution q(xₜ|x_{1:t-1}, z_{1:t}) determined using equation (8) above, particle tracking module 224 readily determines the trajectory over time of the object (the object having the parameters described by xₜ). The proposal distribution for each of multiple different objects in the video can be determined in this manner, and particle tracking module 224 can readily determine the trajectories of those multiple different objects. The objects that are tracked can be identified in different manners. For example, any of a variety of different public or proprietary object detection algorithms (e.g., face detection algorithms, body detection algorithms, shape detection algorithms, etc.) can be used to identify an object in a frame of the video. By way of another example, a user (or alternatively other component or module) can identify an object to be tracked (e.g., a user selection of a particular object in a frame of the video, such as by the user touching or otherwise selecting a point on the object, the user drawing a circle or oval (or other geometric shape) around the object, and so forth).

The result of the particle filtering performed by tracking module 204 is a set of trajectories for objects in input video 210. These object trajectories can be made available to (e.g., passed as parameters to, stored in a manner accessible to, and so forth) various additional components. In the illustrated example of FIG. 2, the object trajectories are made available to a 3D visualization module 206 and/or a video analytics module 208.

3D visualization module 206 renders the registration and tracking results. 3D visualization module 206 assumes the static background in the video has a known parametric geometry that can be estimated from the video. For example, 3D visualization module 206 can assume that this background is planar. 3D visualization module 206 generates 3D models, including backgrounds and objects. In one or more embodiments, these 3D models are generic models for the particular type of video. For example, the generic models can be a generic model of an American football stadium or a soccer stadium, a generic model of an American football player or a soccer player, and so forth. Alternatively, the generic models can be generated based at least in part on input video 210. For example, background colors or designs (e.g., team logos in an American football stadium), player uniform colors, and so forth can be identified in input video 210 by 3D visualization module 206 or alternatively another component or module of system 200. The generic models can be generated to reflect these colors or designs, thus customizing the models to the particular input video 210. 3D visualization module 206 can generate the models using any of a variety of public and/or proprietary 3D modeling and animation techniques, such as the 3ds Max® product available from Autodesk of San Rafael, Calif.

3D visualization module 206 renders the 3D scene with the generated models using any of a variety of public and/or proprietary 3D rendering techniques. For example, 3D visualization module 206 can be implemented using the OpenSceneGraph graphics toolkit product. Additional information regarding the OpenSceneGraph graphics toolkit product is available from the web site “www.” followed by “openscenegraph.org/projects/osg”. The 3D dynamic moving objects are integrated into the 3D scene using various public and/or proprietary libraries, such as the Cal3D and osgCal libraries. The Cal3D library is a skeletal based 3D character animation library that supports animations and actions of characters and moving objects. Additional information regarding the Cal3D library is available from the web site “gna.org/projects/cal3d/”. The osgCal library is an adapter library that allows the usage of Cal3D inside OpenSceneGraph. Additional information regarding the osgCal library is available from the web site “sourceforge.net/projects/osgcal/files/”.

3D visualization module 206 uses the object trajectories identified by tracking module 204 to animate and move the objects in the 3D scene. The animations of objects (e.g., running or walking players) can be determined based on the trajectories of the objects (e.g., an object moving along a trajectory at at least a threshold rate is determined to be running, an object moving along a trajectory at less than the threshold rate is determined to be walking, and an object not moving is determined to be standing still). The speed at which the objects are moving can be readily determined by 3D visualization module 206 (e.g., based on the capture frame rate for the input video).

Given the 3D scene and 3D object models, 3D visualization module 206 allows different views of the 3D scene and object models. For example, a bird's eye view can be displayed, an on-field (player's view) can be displayed, and so forth. Which view is displayed can be selected by a user of system 200, or alternatively another component or module of system 200. A user can select different views in different manners, such as by selecting an object (e.g., a player) to switch from the bird's eye view to the player's view, and selecting the object again (or selecting another icon or button) to switch from the player's view to the bird's eye view. 3D visualization module 206 also allows the view to be manipulated in different manners, such as zooming in, zooming out, rotating about a point (e.g., about an object), pausing the animation, resuming displaying the animation, and so forth.

After tracking the objects in the reference system, these objects can be visualized in a 3D setting by embedding generic 3D object models in a 3D world, with their positions at any given time being determined by their tracks (trajectories). In one or more embodiments, 3D visualization module 206 assumes that the pose of the object is always perpendicular (or alternatively another angle) to the static planar background. In making this assumption, module 206 allows the simulation of different camera views, which could be temporally static or dynamic. For example, the user can choose to visualize the same video from a single camera viewpoint (that can be different from the one used to capture the original video) or from a viewpoint that also moves over time (e.g., when the viewpoint is set at the location of one of the objects being tracked).

Video analytics module 208 facilitates, based on the registration and tracking results, human interpretation and analysis of input video 210. Video analytics module 208 determines various statistics regarding the objects in input video 210 based on the registration and tracking results. These determined statistics can be used in various manners, such as displayed to a user of system 200, stored for subsequent analysis or use, and so forth. Video analytics module 208 can determine any of a wide variety of different statistics regarding the movement (or lack of movement of an object). These statistics can include object speed (e.g., how fast a particular player or other object moves), distance traversed (e.g., how far a football, player, or other object moves), an in-air time for an object (e.g., a hang time for a football punt or how long the ball is in the air for a soccer kick), a direction of an object, starting and/or ending location of an object, and so forth. These statistics can be for individual instances of objects (e.g., the speed of a particular object during each play) or averages (e.g., the average hang time for a football punt). These statistics can also be for particular types of plays. For example, a user input can request statistics for a kickoff, punt, field goal, etc., and the statistics (speed of objects in the play, distance traversed by objects during the play, etc.) displayed to the user. Different types of plays can be identified in different manners, such as similar activities using trajectory similarity as discussed below.

The statistics can be determined by video analytics module 208 using any of a variety of public and/or proprietary techniques, relying on one or more of object trajectories, object locations, the capture frame rate for the input video, and so forth. The manner in which a particular statistic is determined by module 208 can vary based on the particular statistic. For example, the speed of an object can be readily identified based on the number of frames in which the object is moving (based on the object trajectory) and the capture frame rate for the input video. By way of another example, the in-air (e.g., hang time) of a football punt can be determined by identifying the frame in which the punter kicks the ball and the frame in which the ball is caught and dividing the difference between these two frame positions by the video frame rate. The punter position can be readily determined (e.g., the punter being the farthest defensive player along the direction of the kick). The player who catches the ball can also be readily determined (e.g., as the farthest offensive player along the direction of the kick, or as the point on the field where the trajectories of the defensive players meet (e.g., where the trajectories of the defensive players converge if they are extrapolated in time)).

Video analytics module 208 can also perform matching and retrieval of videos based on trajectory similarity, activity recognition, and/or detection of unusual events. Trajectory similarity can be used to retrieve videos by video analytics module 208 receiving an indication (e.g., a user input or indication from another component or module) of a particular trajectory, such as user selection of a particular object in a particular play of an American football game. Other portions of the video (e.g., other plays of the game) and/or portions of other videos having objects with similar trajectories are identified by video analytics module 208. These portions and/or videos are retrieved or otherwise obtained by module 208, and made available to the requesting user (or other component or module), such as for playback of the video itself, display of a 3D scene by 3D visualization module 206, and so forth.

Video analytics module 208 can identify similar trajectories using any of a variety of public and/or proprietary techniques. In one or more embodiments, to identify similar trajectories video analytics module 208 uses one or more well-known dynamic time warping (DTW) algorithms, which measure similarity between two trajectories that can vary in time and/or speed.

Video analytics module 208 can recognize activities in various manners, such as based on trajectory similarity. For example, a user (or other component or module) can indicate to module 208 a particular type of activity for a particular portion of a video (e.g., a particular play of an American football game). Various different types of activities can be identified, such as field goals, kick-offs, punts, deep routes for receivers, crossing routes for receivers, and so forth. Other portions of that video and/or other videos having objects with similar trajectories can be identified by module 208 as portions or videos of similar activities.

Video analytics module 208 can also determine unusual events in various manners, such as based on trajectory similarity. Video analytics module 208 can use the object trajectories to find other objects in other portions of the video and/or in other videos having similar trajectories. If at least a threshold number (e.g., 3 or 5) objects with similar trajectories cannot be identified for a particular object trajectory, then that particular object trajectory (and video and/or portion of the video (e.g., an American football play) including that object trajectory) can be identified by module 208 as an unusual event.

In the illustrated example of FIG. 2, the object trajectories identified by tracking module 204 are discussed as being used by 3D visualization module 206 and/or a video analytics module 208. In addition to, or alternatively in place of, such use for 3D visualization and/or video analytics, the object trajectories can be used in a variety of other manners. For example, the object trajectories can be used in performing video summarization to generate a shorter (summary) version of input video 210. The object trajectories can be used to identify frames of input video 210 to include in a summary version of input video 210 in various manners, such as by identifying frames that include objects having particular trajectories (e.g., at least a threshold number of objects moving at at least a threshold rate), frames including a particular type of activity, frames including unusual events, and so forth.

Some of the discussions herein describe the video analysis based on sparse registration and multiple domain tracking techniques with reference to sporting events. However, as noted above, the techniques discussed herein can be used for a variety of different types of objects and scenes. The techniques discussed herein can be used in any situation in which the monitoring or tracking of people or other objects is desired. For example, the techniques discussed herein can be used for security or surveillance activities to monitor access to restricted or otherwise private areas captured on video (e.g., particular rooms, cashier areas, areas where particular items are sold in a store, outdoor areas where buildings or other structures or items can be accessed, etc.).

Video analytics module 208 can facilitate human interpretation and analysis of input video 210 in these different situations, such as by determining statistics regarding the objects in the video, determining particular activities or unusual events in the video, and so forth. The particular operations performed by video analytics module 208 can vary based on the particular situation, the desires of a developer, user, or administrator of video analytics module 208, and so forth.

For example, various statistics regarding the movement of people in an indoor or outdoor area can be determined. The statistics can be determined by video analytics module 208 using any of a variety of public and/or proprietary techniques, relying on one or more of object trajectories, object locations, the capture frame rate for the input video, and so forth. E.g., these statistics can include how long people stayed in particular areas, the speed of people through a particular area, a number of times people stopped (and a duration of those stops) when moving through a particular area, and so forth. These statistics can be for individual people (e.g., the speed of individual people walking or running through an area) or averages of multiple people (e.g., the average speed of people walking or running through an area).

By way of another example, various different activities or events in an indoor or outdoor area can be determined. These activities or events can be determined using any of a variety of public and/or proprietary techniques, relying on one or more of object trajectories, objects having similar trajectories, object locations, the capture frame rate for the input video, and so forth. E.g., these activities or events can include whether a person entered a particular part (e.g., a restricted or otherwise private part) of an indoor or outdoor area, whether a person stopped for at least a threshold amount of time in a particular part (e.g., where a particular display or item is known to be present) of an indoor or outdoor area, whether a person moved through a particular part of an indoor or outdoor area at greater than (or more than a threshold amount greater than) an average speed of multiple people moving through that particular part, and so forth.

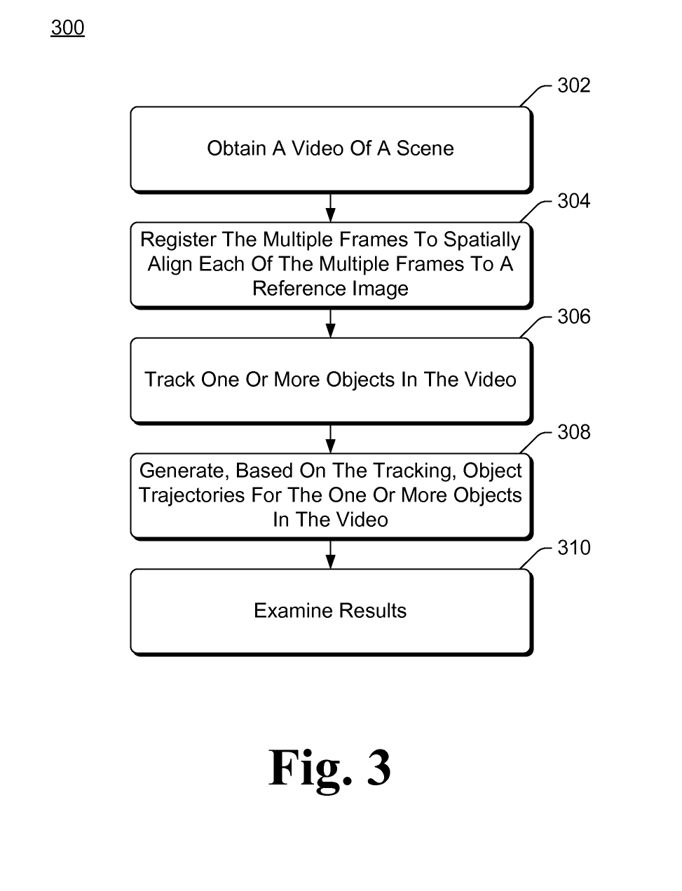

FIG. 3 is a flowchart illustrating an example process 300 for implementing video analysis based on sparse registration and multiple domain tracking in accordance with one or more embodiments. Process 300 can be implemented in software, firmware, hardware, or combinations thereof. Process 300 is carried out by, for example, a video analysis system 106 of FIG. 1 or a system 200 of FIG. 2. Process 300 is shown as a set of acts and is not limited to the order shown for performing the operations of the various acts. Process 300 is an example process for implementing video analysis based on sparse registration and multiple domain tracking; additional discussions of implementing video analysis based on sparse registration and multiple domain tracking are included herein with reference to different figures.

In process 300, a video of a scene is obtained (act 302). The video includes multiple frames, and can be any of a variety of scenes as discussed above.

The multiple frames are registered to spatially align each of the multiple frames to a reference image (act 304). The multiple frames are spatially aligned using sparse registration, as discussed above.

One or more objects in the video are tracked (act 306). This tracking is performed based on the registered multiple frames as well as both an image domain and a field domain, as discussed above.

Based on the tracking, object trajectories for the one or more objects in the video are generated (act 308). These object trajectories can be used in various manners, as discussed above.

The results of acts 302-308 are then examined (act 310). The results are, for example, the object trajectories generated in act 308. The examination can take various forms as discussed above, such as rendering objects in a 3D scene, presenting various statistics, matching and retrieval of videos, and so forth.

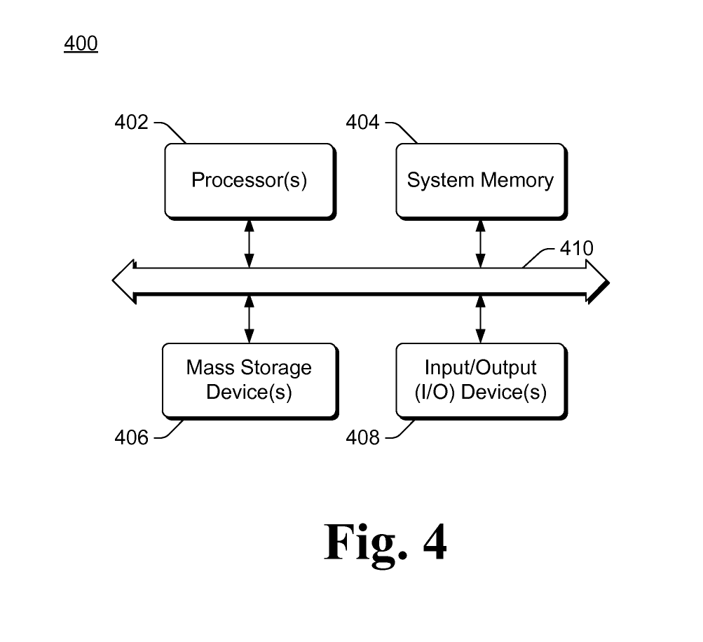

FIG. 4 is a block diagram illustrating an example computing device 400 in which the video analysis based on sparse registration and multiple domain tracking can be implemented in accordance with one or more embodiments. Computing device 400 can be used to implement the various techniques and processes discussed herein. Computing device 400 can be any of a wide variety of computing devices, such as a desktop computer, a server computer, a handheld computer, a laptop or netbook computer, a tablet or notepad computer, a personal digital assistant (PDA), an internet appliance, a game console, a set−top box, a cellular or other wireless phone, audio and/or video players, audio and/or video recorders, and so forth.

Computing device 400 includes one or more processor(s) 402, computer readable media such as system memory 404 and mass storage device(s) 406, input/output (I/O) device(s) 408, and bus 410. One or more processors 402, at least part of system memory 404, one or more mass storage devices 406, one or more of devices 408, and/or bus 410 can optionally be implemented as a single component or chip (e.g., a system on a chip).

Processor(s) 402 include one or more processors or controllers that execute instructions stored on computer readable media. The computer readable media can be, for example, system memory 404 and/or mass storage device(s) 406. Processor(s) 402 may also include computer readable media, such as cache memory. The computer readable media refers to media that enables persistent and/or non-transitory storage of information in contrast to mere signal transmission, carrier waves, or signals per se. Thus, computer readable media refers to non-signal bearing media. However, it should be noted that instructions can also be communicated via various computer readable signal bearing media rather than computer readable media.

System memory 404 includes various computer readable media, including volatile memory (such as random access memory (RAM)) and/or nonvolatile memory (such as read only memory (ROM)). System memory 404 may include rewritable ROM, such as Flash memory.

Mass storage device(s) 406 include various computer readable media, such as magnetic disks, optical discs, solid state memory (e.g., Flash memory), and so forth. Various drives may also be included in mass storage device(s) 406 to enable reading from and/or writing to the various computer readable media. Mass storage device(s) 406 include removable media and/or nonremovable media.

I/O device(s) 408 include various devices that allow data and/or other information to be input to and/or output from computing device 400. Examples of I/O device(s) 408 include cursor control devices, keypads, microphones, monitors or other displays, speakers, printers, network interface cards, modems, lenses, CCDs or other image capture devices, and so forth.

Bus 410 allows processor(s) 402, system 404, mass storage device(s) 406, and I/O device(s) 408 to communicate with one another. Bus 410 can be one or more of multiple types of buses, such as a system bus, PCI bus, IEEE 1394 bus, USB bus, and so forth.

Generally, any of the functions or techniques described herein can be implemented using software, firmware, hardware (e.g., fixed logic circuitry), manual processing, or a combination of these implementations. The terms “module” and “component” as used herein generally represent software, firmware, hardware, or combinations thereof. In the case of a software implementation, the module or component represents program code that performs specified tasks when executed on a processor (e.g., CPU or CPUs). The program code can be stored in one or more computer readable media, further description of which may be found with reference to FIG. 4. In the case of hardware implementation, the module or component represents a functional block or other hardware that performs specified tasks. For example, in a hardware implementation the module or component can be an application-specific integrated circuit (ASIC), field-programmable gate array (FPGA), complex programmable logic device (CPLD), and so forth. The features of the inserting objects into content techniques described herein are platform-independent, meaning that the techniques can be implemented on a variety of commercial computing platforms having a variety of processors.

Although the description above uses language that is specific to structural features and/or methodological acts in processes, it is to be understood that the subject matter defined in the appended claims is not limited to the specific features or processes described. Rather, the specific features and processes are disclosed as example forms of implementing the claims. Various modifications, changes, and variations apparent to those skilled in the art may be made in the arrangement, operation, and details of the disclosed embodiments herein.

What is claimed is:

1. A method implemented in one or more computing devices, the method comprising:
obtaining a video of a scene, the video including multiple frames;
registering, using sparse registration, the multiple frames to spatially align each of the multiple frames to a reference image;
tracking, based on the registered multiple frames as well as both an image domain and a field domain, one or more objects in the video; and
generating, based on the tracking, an object trajectory for each of the one or more objects in the video.

2. A method as recited in claim 1, the video having been captured by one or more moving cameras.

3. A method as recited in claim 1, the sparse registration assuming that pixels belonging to moving objects in each video frame are sufficiently sparse.

4. A method as recited in claim 1, the registering being based on matching entire images or image patches.

5. A method as recited in claim 1, the registering comprising generating a sequence of homographies that map the multiple frames to the reference image.

6. A method as recited in claim 1, the video including multiple video sequences of a scene, each video sequence having been captured from a different point viewpoint, the registering further comprising:
generating, for each video sequence, a sequence of homographies that map the multiple frames of the video sequence to the reference image;
receiving, for each video sequence, a user input identifying corresponding pixels in a frame of the video sequence and the reference image;
generating, for each video sequence based on the identified corresponding pixels, a frame-to-reference homography;
combining, for each video sequence, the frame-to-reference homography and the sequence of homographies that map the multiple frames of the video sequence to the reference image.

7. A method as recited in claim 1, the field domain including a full area of a scene despite one or more portions of the scene being excluded from one or more of the multiple frames.

8. A method as recited in claim 1, the tracking comprising using particle filtering to track the one or more objects in the video.

9. A method as recited in claim 1, the tracking being based at least in part on intra-trajectory contextual information that is based on history tracking results in the field domain.

10. A method as recited in claim 9, the tracking being further based at least in part on inter-trajectory contextual information extracted from a dataset of trajectories computed from multiple additional videos.

11. A method as recited in claim 1, further comprising displaying a 3D scene with 3D models animated based on the object trajectories.

12. A method as recited in claim 1, further comprising:
determining, based on the object trajectories, one or more statistics regarding the one or more objects; and
displaying the one or more statistics.

13. One or more computer readable media having stored thereon multiple instructions that, when executed by one or more processors of one or more devices, cause the one or more processors to perform acts comprising:
obtaining a video of a scene, the video including multiple frames;
registering, using sparse registration, the multiple frames to spatially align each of the multiple frames to a reference image;
tracking, based on the registered multiple frames as well as both an image domain and a field domain, one or more objects in the video; and
generating, based on the tracking, an object trajectory for each of the one or more objects in the video.

14. One or more computer readable media as recited in claim 13, the video having been captured by one or more static or moving cameras.

15. One or more computer readable media as recited in claim 13, the sparse registration assuming that pixels belonging to moving objects in each video frame are sufficiently sparse.

16. One or more computer readable media as recited in claim 13, the registering being based on matching entire images or image patches.

17. One or more computer readable media as recited in claim 13, the registering comprising generating a sequence of homographies that map the multiple frames to the reference image.

18. One or more computer readable media as recited in claim 13, the video including multiple video sequences of a scene, each video sequence having been captured from a different point viewpoint, the registering further comprising:
generating, for each video sequence, a sequence of homographies that map the multiple frames of the video sequence to the reference image;
receiving, for each video sequence, a user input identifying corresponding pixels in a frame of the video sequence and the reference image;
generating, for each video sequence based on the identified corresponding pixels, a frame-to-reference homography;
combining, for each video sequence, the frame-to-reference homography and the sequence of homographies that map the multiple frames of the video sequence to the reference image.

19. One or more computer readable media as recited in claim 13, the field domain including a full area of a scene despite one or more portions of the scene being excluded from one or more of the multiple frames.

20. One or more computer readable media as recited in claim 13, the tracking comprising using particle filtering to track the one or more objects in the video.

21. One or more computer readable media as recited in claim 13, the tracking being based at least in part on intra-trajectory contextual information that is based on history tracking results in the field domain.

22. One or more computer readable media as recited in claim 21, the tracking being further based at least in part on inter-trajectory contextual information extracted from a dataset of trajectories computed from multiple additional videos.

23. One or more computer readable media as recited in claim 13, the acts further comprising displaying a 3D scene with 3D models animated based on the object trajectories.

24. One or more computer readable media as recited in claim 13, the acts further comprising:
determining, based on the object trajectories, one or more statistics regarding the one or more objects; and
displaying the one or more statistics.

25. A device comprising:
one or more processors; and
one or more computer readable media having stored thereon multiple instructions that, when executed by the one or more processors, cause the one or more processors to:
obtain a video of a scene, the video including multiple frames;
register, using sparse registration, the multiple frames to spatially align each of the multiple frames to a reference image;
track, based on the registered multiple frames as well as both an image domain and a field domain, one or more objects in the video; and
generate, based on the tracking, an object trajectory for each of the one or more objects in the video.
